(19) United States
(12) Patent Application Publication
(10) Pub. No.: US 2007/0213968 A1
(43) Pub. Date: Sep. 13, 2007

(54) User Interface Software Design System

(75) Inventors: Takashi Nakagawa, Tokyo (JP); Hiroki Konaka, Tokyo (JP); Shinichiro Tsudaka, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/574,785

(22) PCT Filed: Oct. 14, 2004
(86) PCT No.: PCT/JP04/15124

§ 371 Date: Mar. 8, 2007

(30) Foreign Application Priority Data
Oct. 16, 2003 (JP) 2003-356608

(51) Int. Cl. G06F 17/50

(52) U.S. Cl. 703/14

(57) ABSTRACT

In order to improve efficiency of user interface software design and development according to differential development, a rule processor reads out unorganized design data stored in an unorganized design data storage, which has been designed by individual software designers and accumulated, and an organizing rule group, stored in a rule storage, applies in series each organizing rule in the organizing rule group to the read-out unorganized design data, and analyzes the result. The rule processor then converts the unorganized design data, by performing division, unification, or the like, into highly reusable organized design data.

### TECHNICAL FIELD

The present invention relates to user interface software design systems for improving efficiency of design and development of user interface software used in devices equipped with software products, such as cellular phones, personal digital assistants, and car navigation systems.

### BACKGROUND ART

In the field of devices equipped with software products, such as cellular phones, personal digital assistants, and car navigation systems, in recent years, shortening of the product life-cycle is significant due to advance in technology and dizzying pace of change in needs for such devices. In order to cope with such situations, improvement of efficiency of new product development, particularly design and development of software products, is required, so that there is an urgent need to accelerate the software product development by improving efficiency of development of user interface software that is important part of software products installed in the devices. User interface software design systems derive from such backgrounds in order to improve the efficiency of design and development of the user interface software.

In general, in software development, differential development is important in which, in order to improve efficiency of design and development, assets such as past design data are reused as much as possible, and only portions different from those of the past, such as new features, are newly designed. In the meanwhile, design data used for designing user interface software has been mostly made according to software designer's discretion of the time, so that most of design data has been inconvenient for reuse. For example, there have been cases in which substantially identical series of scenes are defined in a plurality of design data segments, or in which, by treating, as scene transitions in the same level, movement of user interfaces such as icons, occupying a portion of the screen, and switching of the entire screen, the scene transitions are planar and the number of scene transitions are large, so that the view of the entire design data gets worse. As described above, design concepts of individual designers are reflected without being unified in user interface software design data. As a result, the design data has not been sufficiently examined from the viewpoint of reusability, so that most of the design data has low reusability. In such circumstances, software designers create required design data by editing design data accumulated in the past each time when newly designing and developing user interface software, using a variety of editing means, being user interface design means, such as a state set editor, an event processing editor, a property editor, and a state display editor, and input the created data into a user interface software design system (see Patent document 1, for instance). Such a situation also results from the fact that design data creation is an extremely creative work, and highly depends on individual ability.

As described above, even when carrying out a differential development, regarding design data, the creation thereof often takes a lot of man-hours. Therefore, the purpose of differential developments in which the efficiency by reusing design data assets accumulated in the past is promoted has not been realized.

In the meanwhile, as a measure against a case in which past design data cannot be obtained in a form highly reusable for a new user interface software development, there is a method so-called reverse engineering. The method obtains design data by inputting and analyzing source codes of software in the past. There is a system therefor referred to as a reverse engineering support system (see Patent document 2, for example). An existing reverse engineering support system analyzes software structures using source codes as input data. Source codes of user interface software are often written in a form of event driven type that determines responses according to interaction with a user (more specifically, a system in which processing to be applied has been defined for each event, and activated according to the definition), so that it has been difficult to interpret the design information of the software from the source codes, and to obtain design data in an organized form so as to be easily reused.

Patent document 1: Japanese Patent Laid-Open No. 244848/2002 (claim 1, pages 3 and 4, and FIG. 1)

Patent document 2: Japanese Patent Laid-Open No. 101884/1997 (claim 1)

### DISCLOSURE OF THE INVENTION

[Problem that the Invention is to Solve]

As described above, because design data accumulated from the past has been created by individual designers not based on unified design concepts, the reusability is low. In order to improve efficiency of differential developments of software, a means for improving the reusability of the accumulated design data has been desired.

[Means for Solving the Problem]

A user interface software design system of the present invention includes: an unorganized design data storage for storing as unorganized design data user-interface-software design data including events directed to a software product and information on software-product scene changes corresponding to the events; a rule storage for storing an organizing rule group, being a collection of organizing rules describing rules for converting the unorganized design data into reusable form; a rule processor for converting the unorganized design data into organized design data by reading out the unorganized design data stored in the unorganized design data storage and reading out the organizing rule group stored in the rule storage, and applying in sequence to the read-out unorganized design data each organizing rule included in the read-out organizing rule group, to analyze the unorganized design data; and an organized design data storage for storing the organized design data according to instruction by the rule processor.

[Effects of the Invention]

A user interface software design system relevant to the above-described invention converts unorganized design data that has been created not based on design concepts unified with each other during the design and development thereof, and that has been accumulated in an inconvenient form for reuse into highly reusable organized design data, whereby understanding of designer's intentions and user interface structures becomes easy, and efficiency of differential developments of user interface software and software products including the user interface software can be improved.

### BRIEF DESCRIPTION OF DRAWINGS

FIG. 1 is a block diagram of a user interface software design system relevant to Embodiment 1 of the present invention.

FIG. 2 illustrates conversion procedures from unorganized design data into organized design data relevant to Embodiment 1 of the present invention.

FIG. 3 (a) illustrates a first example of an organizing rule relevant to Embodiment 1 of the present invention; FIG. 3 (b) illustrates a first example of unorganized design data relevant to Embodiment 1 of the present invention; and FIG. 3 (c) illustrates a first example of organized design data relevant to Embodiment 1 of the present invention.

FIG. 4 (a) illustrates a second example of an organizing rule relevant to Embodiment 1 of the present invention; FIG. 4 (b) illustrates a second example of unorganized design data relevant to Embodiment 1 of the present invention; and FIG. 4 (c) illustrates a second example of organized design data relevant to Embodiment 1 of the present invention.

FIG. 5 is a block diagram of a user interface software design system relevant to Embodiment 2 of the present invention.

FIG. 6 illustrates detailed procedures relevant to Embodiment 2 of the present invention.

FIG. 7 (a) illustrates a first example of organizing rules relevant to Embodiment 2 of the present invention; FIG. 7 (b) illustrates a first example of unorganized design data relevant to Embodiment 2 of the present invention; and FIG. 7 (c) illustrates a first example of organized design data relevant to Embodiment 2 of the present invention.

FIG. 8 (a) illustrates a second example of organizing rules relevant to Embodiment 2 of the present invention; FIG. 8 (b) illustrates a second example of unorganized design data relevant to Embodiment 2 of the present invention; and FIG. 8 (c) illustrates a second example of organized design data relevant to Embodiment 2 of the present invention.

FIG. 9 is a block diagram of a user interface software design system relevant to Embodiment 3 of the present invention.

FIG. 10 illustrates detailed procedures after STEP 2 relevant to Embodiment 3 of the present invention.

FIG. 11 (a) illustrates an example of a menu template relevant to Embodiment 3 of the present invention; FIG. 11 (b) illustrates a first example of unorganized design data relevant to Embodiment 3 of the present invention; and FIG. 11 (c) illustrates a first example of organized design data relevant to Embodiment 3 of the present invention.

FIG. 12 illustrates detailed procedures after STEP 2 of another example relevant to Embodiment 3 of the present invention.

FIG. 13 (a) illustrates an example of an organizing rule relevant to Embodiment 3 of the present invention; FIG. 13 (b) illustrates a second example of unorganized design data relevant to Embodiment 3 of the present invention; and FIG. 13 (c) illustrates a second example of organized design data relevant to Embodiment 3 of the present invention.

FIG. 14 is a block diagram of a user interface software design system relevant to Embodiment 5 of the present invention.

### DESCRIPTION OF THE SYMBOLS

1: design data storage; 2: model analyzer; 3: input information generator; 4: software product; 5: model generator; 6: design data editor; 7: rule editor; 110: unorganized design data; 120: organized design data; 21: rule storage: 22: rule processor; 211, 212, 213, 214, and 216: organizing rules; 215: menu template.

### BEST MODE FOR CARRYING OUT THE INVENTION

### Embodiment 1

Design data required for design and development of user interface software, which is a target of the invention relevant to the present application, is defined as scene change information referred to as scene sequences composed of a series of events to a software product (inputs by various operations, configurations, or the like) and display scenes that are switched by each event. The design data has a feature that the design data is more simplified compared with design data for general software. The invention relevant to the present application focuses on this point, and converts design data into an objectively and easily understandable form to improve reusability of the design data.

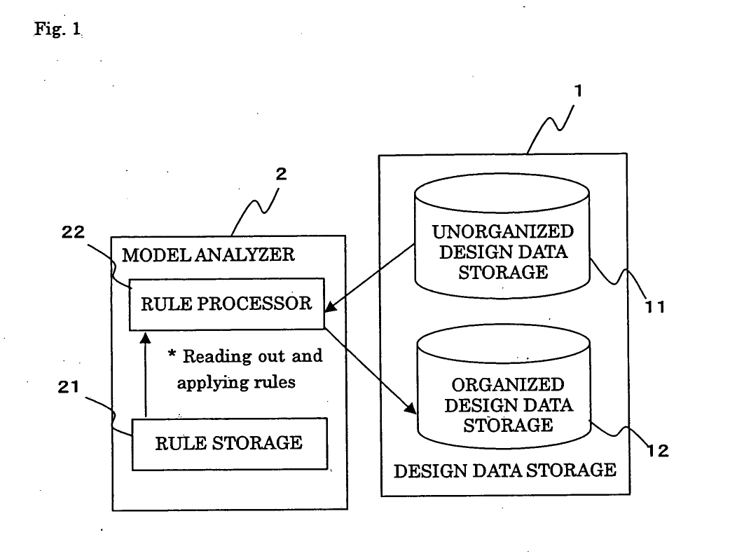

FIG. 1 illustrates the configuration of Embodiment 1 of the present invention. In the diagram, an unorganized design data storage 11 is a storage for storing and accumulating unorganized design data that individual software designers created at each time in the past, whereby design concepts are not unified with each other, and that has not been organized in a reusable form, and an organized design data storage 12 is a storage for storing and accumulating organized design data into which the unorganized design data has been converted as a reusable form based on later-described predetermined rules. In FIG. 1, a design data storage 1 is illustrated to include the unorganized design data storage 11 and the organized design data storage 12, which indicates that the unorganized design data storage 11 and the organized design data storage 12 can be integrated as a unit, and an unorganized design data storage 11 and an organized design data storage 12 can be configured within the unit. A model analyzer 2 includes a rule storage 21 and a rule processor 22. The rule storage 21 has a function for storing a group of organizing rules for converting unorganized design data into organized design data in a reusable form. The rule processor 22 has functions for, by reading out the group of organizing rules from the rule storage 21, applying in series each organizing rule included in the organizing rule group, analyzing the unorganized design data read out from the unorganized design data storage 11, and performing processing such as layering, unification, branching, and division, converting the unorganized design data into organized design data, and sending an instruction for storing the converted data in the organized design data storage 12.

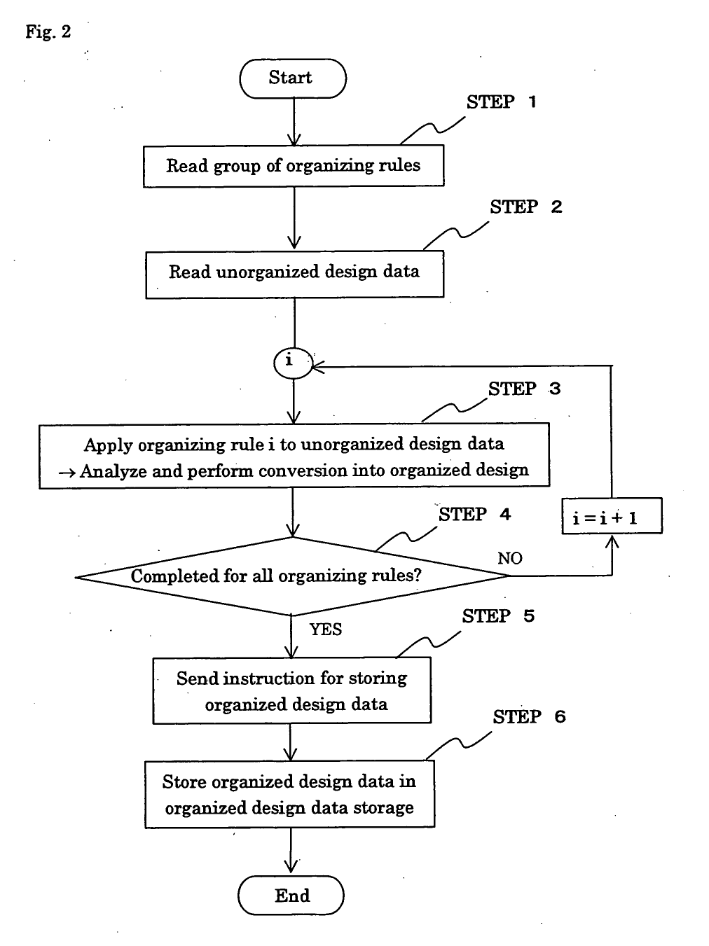

FIG. 2 is a diagram explaining procedures in converting unorganized design data into organized design data relevant to the present Embodiment 1. Hereinafter, the procedures will be described according to the diagram. The rule processor 22 reads the organizing rule group stored in the rule storage 21 (STEP 1), and further reads the unorganized design data stored in the unorganized design data storage 11 (STEP 2).

Next, the rule processor 22 applies in series each organizing rule included in the organizing rule group to the unorganized design data having been read. Each organizing rule includes a “condition” of application, and “applying process” describing the content of a process by the organizing rule. If the unorganized design data includes a portion that meets the “condition”, according to the “applying process”, conversions such as layering, unification, and division are performed on the unorganized design data (STEP 3). The processing in STEP 3 is performed on the entire unorganized design data. When the processing is completed, the rule processor 22 judges whether the processing in STEP 3 has been completed for all the organizing rules. If the rule processor judges that the processing has been completed (YES in STEP 4), the rule processor sends an instruction for storing in the organized design data storage 12 the design data after above-described conversion (STEP 5). The organized design data storage 12 stores the converted design data as organized design data according to the instruction by the rule processor 22 (STEP 6). If the rule processor 22 determines that there are organizing rules on which the processing in STEP 3 has not been performed, the rule processor 22 performs the processing in STEP 3 on the next organizing rule.

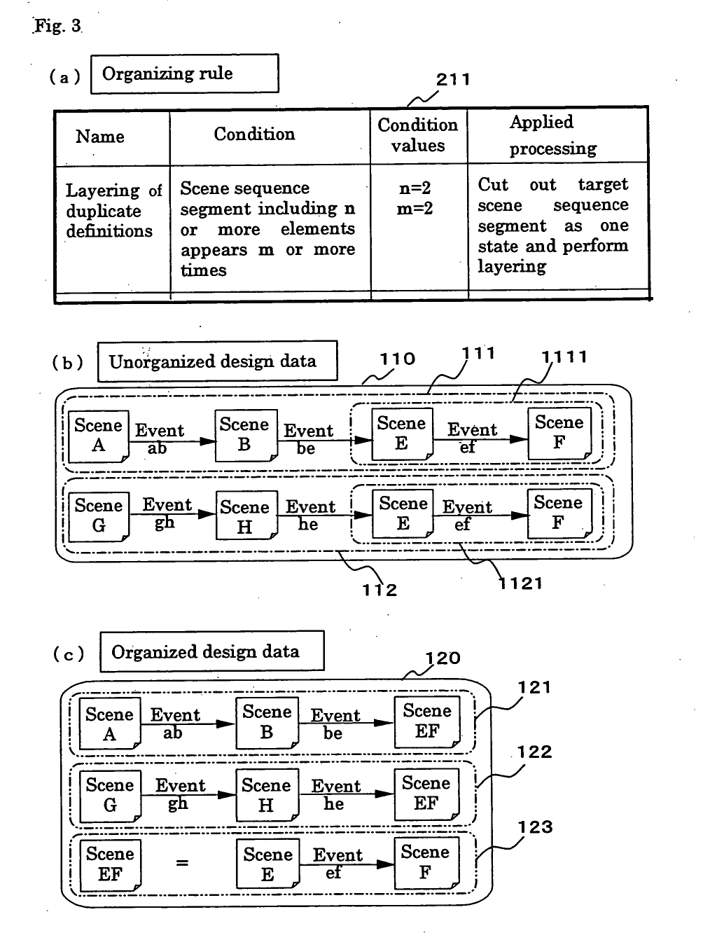

FIG. 3 illustrates a specific example of unorganized design data, and an example in which a specific organizing rule has been applied to the unorganized design data. FIG. 3 (a) illustrates an example of organizing rules included in the organizing rule group as an organizing rule 211. In the organizing rule 211, the “name” of the rule, a “condition” of applying the rule, “condition values” indicating value criteria for the condition, and “applying process” indicating the content of a process performed on the unorganized design data when the condition is satisfied are written. The organizing rule 211 illustrated here is an example in which an organizing rule is expressed in table form. FIG. 3 (b) illustrates an example of unorganized design data 110 as scene sequences 111 and 112. A portion extracted from a scene sequence is referred to as a scene sequence segment. Numerals 1111 and 1121 in the scene sequences 111 and 112 indicate examples of scene sequence segments of the scene sequences 111 and 112, respectively. FIG. 3 (c) illustrates organized design data as scene sequences 121 through 123. The scene sequences 121 through 123 are portion of the organized design data 120, and the organized design data usually includes the other portion of the organized design data.

Next, a conversion procedure in STEP 3 in FIG. 2 will be described using the example in FIG. 3. Firstly, the rule processor 22 searches unorganized design data having been read in STEP 2 from the unorganized design data storage 11 for whether or not there is unorganized design data that matches the “condition” of the organizing rule 211 in FIG. 3 (a), having been read in STEP 1 from the rule storage 21. The “condition values” are considered in search for the “condition” match. When focusing on the scene sequences 111 and 112 in FIG. 3 (b), which are unorganized design data, portions in which an event ef arises in a scene E and a scene transition to a scene F occurs (scene sequence segments 1111 and 1121) are common. However, the common portions are independently written in each scene sequence, so that the two design data segments are written in complicated expressions. The rule processor 22 performs on the unorganized design data the processing to “cut out a target scene sequence segment as one state and perform layering” written in “applying process” in the organizing rule 211, to organize and unify the unorganized design data. As a result, by newly defining a scene EF, the rule processor 22 converts the organized design data into layered design data as the scene sequences 121 through 123 illustrated in FIG. 3 (c). More specifically, when unorganized design data sequences having an identical scene sequence segment consisting of n (the number of scenes constituting a scene sequence segment, n=2 in the example) elements appear in the scene sequences in the unorganized design data m (m=2 in this example) or more times, the processing according to the organizing rule 211 is to cut out the common scene sequence segments as the scene EF and to perform layering, or to substitute one scene for a scene sequence segment having high frequency of appearance. FIG. 3 illustrates an example in which an identical scene sequence segment is present within each of the two scene sequences of the unorganized design data. However, when the number of scene sequences within the unorganized design data is more than two, or when an identical scene sequence segment appears a plurality of times within a single scene sequence of the unorganized design data, similar processing can be performed.

By unifying unorganized data as above, when performing various processing such as enhancement, reduction, modification of functions for the scene sequence segments 1111 and 1121 for example, a software designer is not required to perform the processing for each of the scene sequence segments 1111 and 1121, but is required to perform necessary processing only for a definition portion of the scene EF illustrated as the organized design data 123, so that the processing can be largely simplified. The condition values n and m are predetermined values, and are determined with attention to their large effect on the software design.

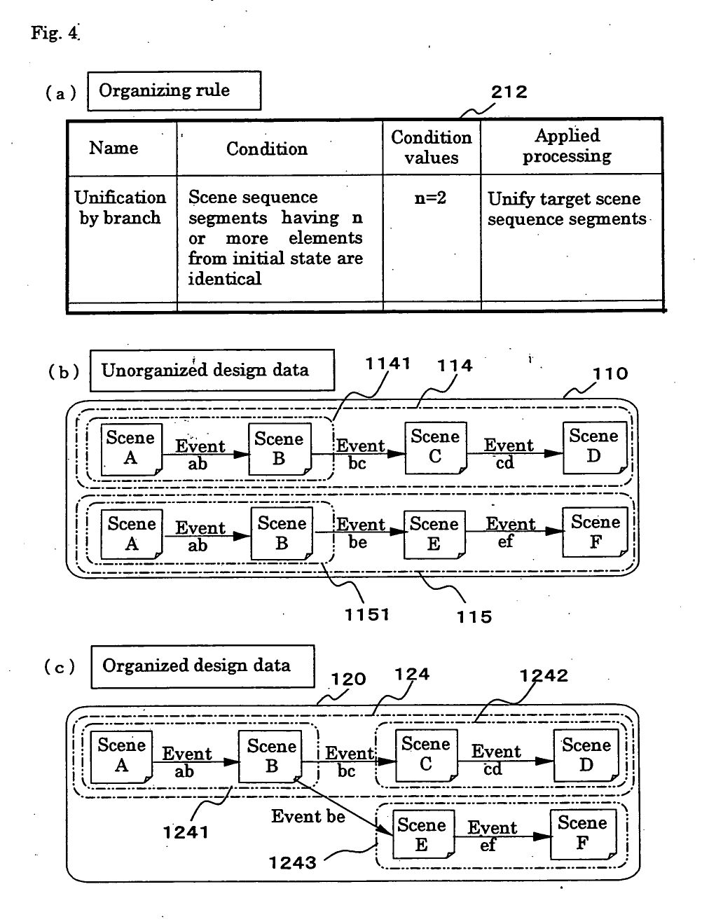

FIG. 4 is a diagram illustrating an example of applying another organizing rule. FIG. 4 (a) illustrates another example of organizing rules included in the organizing rule group as an organizing rule 212. As written in the fields of “name”, “condition”, and “applying process”, regarding a plurality of corresponding scene sequences in unorganized design data, if scene sequence segments consisting of n elements from the head of each scene sequence are identical, the organizing rule 212 unifies the plurality of scene sequences using a branch. FIG. 4 (b) illustrates a case in which a scene sequence segment 1141 at the head of a scene sequence 114 and a scene sequence segment 1151 at the head of a scene sequence 115, included in the unorganized design data 110, are identical. In this case, the unorganized design data is converted into organized design data 1200 according to the organizing rule 212 by the rule processor 22. As illustrated in FIG. 4 (c), the converted organized design data 1200 is expressed by a common scene sequence segment 1241 (identical to the scene sequence segments 1141 and 1151 equal to each other) and scene sequence segments 1242 and 1243 that branch therefrom. FIG. 4 is an example in which an identical scene sequence is included in each of the two scene sequences in unorganized design data. This type of processing can deal with cases in which more scene sequences are included in unorganized design data.

By unifying unorganized data as above, when performing processing such as enhancement, reduction, modification of functions for the scene sequence segments 1141 and 1151 for example, a software designer is not required to perform the processing for each of the scene sequence segments 1141 and 1151, but is required to perform necessary processing only for the scene sequence segment 1241 in the organized design data. Moreover, in this example, because the branch structure is clearly expressed in the organized design data, the software designer can easily perform processing such as enhancement, reduction, modification of functions by branch increase and decrease processing, so that the processing can be largely simplified compared with performing similar processing for unorganized design data, and development efficiency can be improved. Furthermore, simplifying the processing improves reliability of completed software. The condition value n for the organizing rule 212 is a predetermined value, and is determined with attention to its large effect on the software design.

As described in the above two examples, using a rule storage 21 for storing a group of organizing rules, and the rule processor 22 for applying each organizing rule in the organizing rule group to the existing unorganized design data stored in the design data storage 1, the existing unorganized design data is processed by layering, unification, branching, division, or the like, to be converted into organized design data that is so organized that the design data structure is easy to understand. If unorganized design data is reused without modification, a software designer must examine, without seeing the software structure, the processing required for reuse for each design data to be reused when performing software function enhancement, reduction, or modification, or software structure modification, so that the design is accompanied by large difficulties. However, by performing the above-described organization, a software designer can easily understand other software designers' design intents, so that accumulated design data can be easily reused in performing software function enhancement, reduction, or modification, or software structure modification.

In addition, in the above description, two types of organizing rules have been explained as examples. However, the invention relevant to the present embodiment is not limited to these organizing rules, and the same effects can be achieved for other organizing rules. Moreover, the organizing rules have been expressed in table form, but are not limited to table form. It is only necessary that “conditions (including condition values)” and “applying process” that is performed when the conditions are satisfied are described therein. For example, even if the organizing rules are expressed in IF-THEN rules or other forms, effects similar to the above can be achieved. In addition, the relation between the unorganized design data storage 11 and the organized design data storage 12, and the design data storage 1 can be arbitrarily configured as having been described. In any of the configurations, effects similar to the above can be achieved.

Moreover, in the above description, the rule processor 22 applies all the organizing rules to the unorganized design data only one time. However, the rules can be applied a plurality of times. In a plurality of times of applications, the organized design data in the previous cycle is treated as unorganized design data. By repeatedly applying organizing rules as just described, the organization of the design data is promoted, and the design data can be converted into more reusable design data.

### Embodiment 2

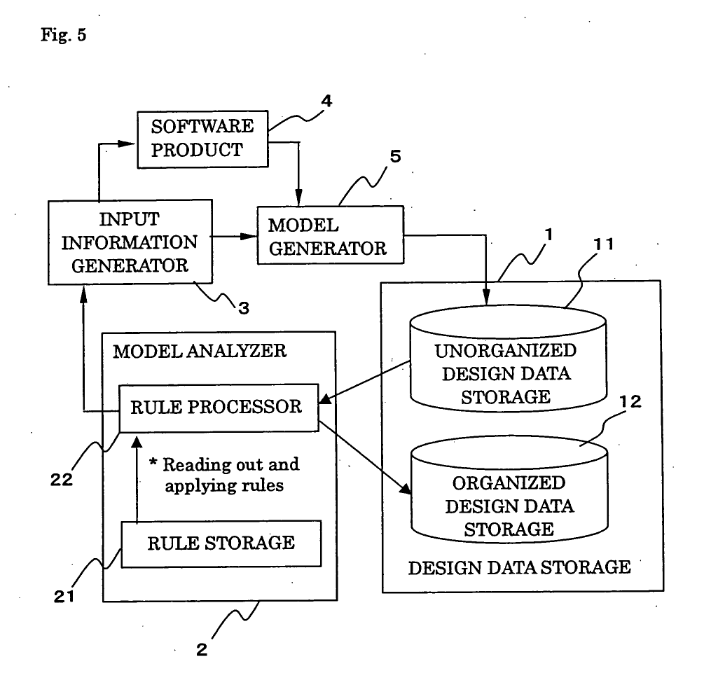

In an invention according to Embodiment 2, even if sufficient unorganized design data required for satisfying “conditions” of organizing rules is not accumulated, by newly generating and complementing unorganized design data, a state in which “conditions” of the organizing rule are satisfied is created to promote organization. FIG. 5 illustrates the configuration of the invention according to Embodiment 2. It is so configured that an input information generator 3 and a model generator 5 are added to the configuration of Embodiment 1. The input information generator 3 generates an event according to an instruction from the rule processor 22, and inputs the event into a software product 4 that is a basis for differential development. To the model generator 5, information on display scene change generated in the software product 4 by the inputted event, and the inputted event are inputted. These inputs are combined together as a scene sequence, and the scene sequence is used as model design data. Then the model generator sends an instruction for storing the model design data in the unorganized design data storage 11 as a portion of unorganized design data. The other components are the same as in Embodiment 1. More specifically, by adding the input information generator 3 and the model generator 5 to the configuration illustrated in FIG. 1 in Embodiment 1, a means for newly generating and complementing unorganized design data via the software product 4 as a basis for differential development is provided. If the unorganized design data for satisfying the “conditions” of the organizing rule is sufficiently provided by this complement, the organization of unorganized design data according to the organizing rule is promoted.

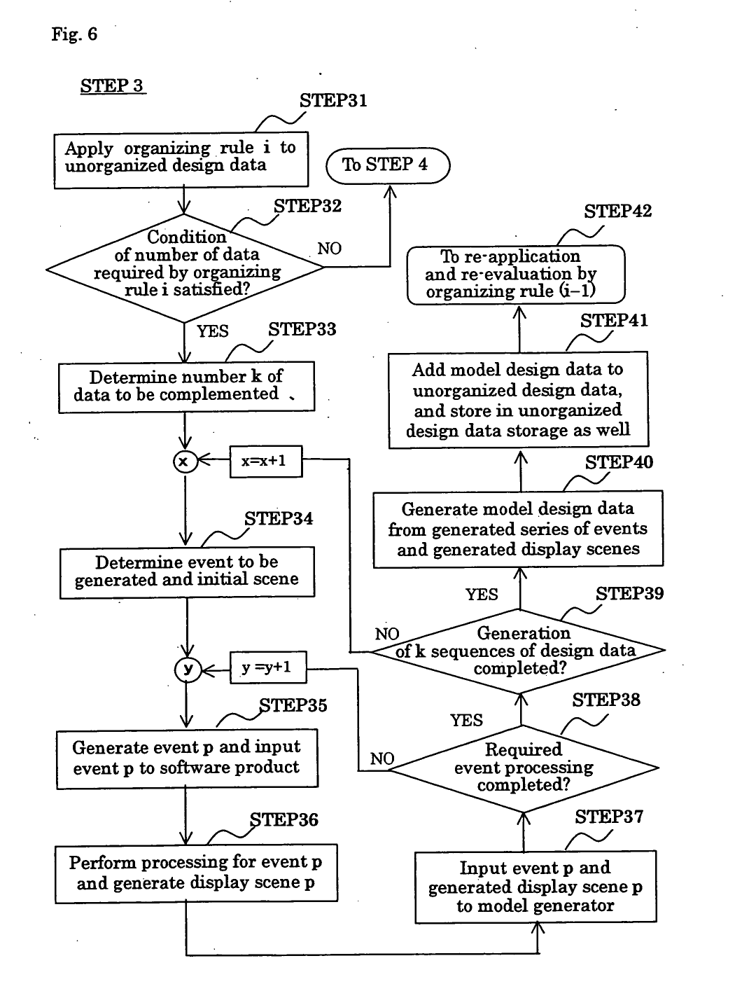

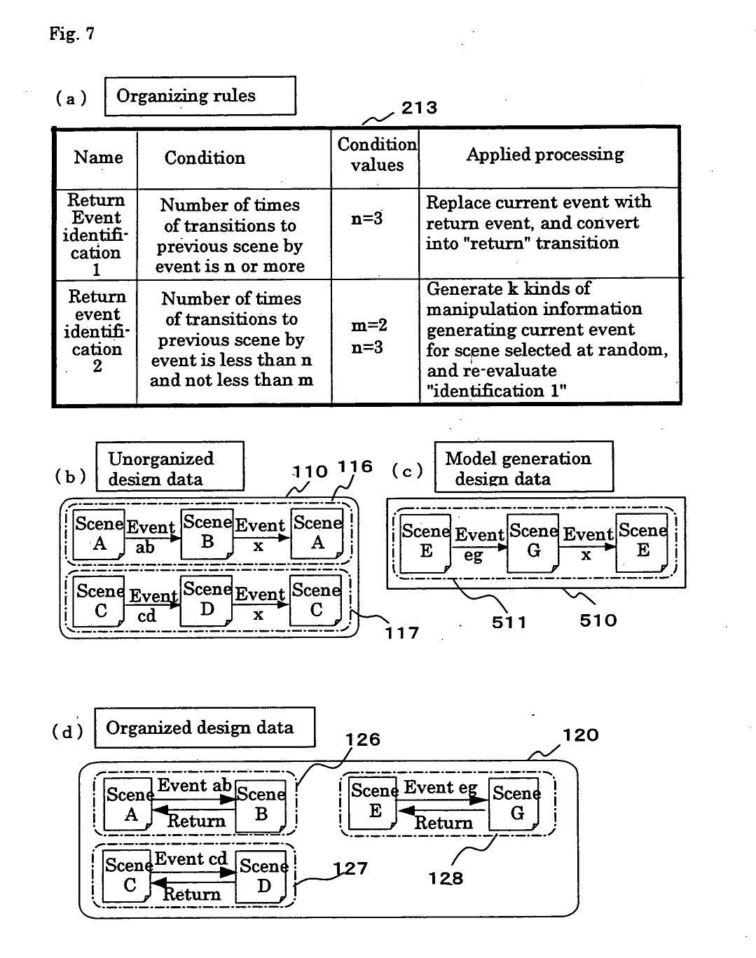

The procedures for converting unorganized design data into organized design data according to the present embodiment are illustrated in FIG. 2 and FIG. 6. Although explanation of FIG. 2 is the same as the explanation in Embodiment 1, it is assumed that STEP 3 in FIG. 2 follows the procedures in FIG. 6. FIG. 7 illustrates specific examples of organizing rules, unorganized design data, and organized design data, for explaining the present embodiment. FIG. 7 (a) illustrates another example of organizing rules different from those described in Embodiment 1; FIG. 7 (b) illustrates an example of unorganized design data corresponding to the organizing rules; and FIG. 7 (d) illustrates an example of organized design data organized according to the organizing rules. As illustrated in FIGS. 7 (a) and (b), the processing illustrated in the example is a “return event” for, by an event x being inputted to an arbitrary scene, returning from the scene to the previous scene. In “return event identification 1” in the organizing rule 213 illustrated in FIG. 7 (a), “conditions” for identifying a portion of unorganized design data as a “return event” and for performing organization, and the content of “applying process” when the condition is satisfied are written.

If the “condition” is satisfied, the unorganized design data is converted into organized design data according to the content written in the “applying process” in the organizing rule 213 (using the “return event” in this example). The above-described processing is the same as described in Embodiment 1. However, there can be a case in which some unorganized design data is excluded from data to be organized because the condition is not satisfied, and the organization of the unorganized design data cannot proceed. In order to reduce such cases as much as possible, another organizing rule “return event identification 2” is placed after the organizing rule “return event identification 1”. If the “condition” of the “return event identification 2” is satisfied, design data is complemented according to “applying process” in the “return event identification 2”, and the complemented design data is included in the unorganized design data. Then the complemented unorganized design data is re-evaluated according to the “return event identification 1”.

The above-described processing will be explained according to FIG. 2 and FIG. 6. The procedures in STEP 1 and STEP 2 in FIG. 2 are the same as in Embodiment 1, so that the explanations thereof will be omitted. As having been explained, FIG. 6 illustrates in detail the procedures corresponding to STEP 3 in FIG. 2. Firstly, the rule processor 22 applies to unorganized design data 110 the “condition” of the first organizing rule “return event identification 1” included in the organizing rule 213 in FIG. 7 (a) (here, i=1 for simplifying the explanation) (STEP 31 in FIG. 6), to judge whether the “condition” is satisfied (STEP 32). In the unorganized design data 110 illustrated in FIG. 7 (b), there are only two applicable data segments, and the condition requiring “three times” is not satisfied. Therefore, the rule processor 22 returns the processing to STEP 4 in FIG. 2. Next, the rule processor 22 applies to unorganized design data 110 the “return event identification 2” corresponding to i=2 (STEP 31), to judge whether the “condition” of the organizing rule is satisfied (STEP 32). If the condition is not satisfied, STEP 4 ensues again. Then the processing relevant to the present embodiment is completed, and the processing for another organizing rule is started (STEP 4 in FIG. 2). If the condition of the above-described “return event identification 2” is satisfied, the rule processor 22 moves the processing to the process of complementing design data (STEP 33 through STEP 39).

As described below, the complement is carried out by inputting an event into the software product 4 that is a basis for differential development. The rule processor 22 firstly determines the number k of data segments to be complemented (STEP 33). The value of k is a value written in the “applying process” in the “return event identification 2”, which should be arbitrarily determined in advance. Next, the rule processor 22 analyzes the organizing rule which is determined to require data complement, or more specifically analyzes the “applying process” in the “return event identification 1” in this example, to determine from what scene to start, and what kind of events are needed, when a series of scene sequence is complemented as design data (STEP 34). Regarding an initial scene to which an event is inputted at the beginning, depending on what type of design data is complemented, there are cases in which a scene sequence can start from an arbitrary scene, and cases in which a scene sequence must start from a specific scene. It is much the same for events. There are cases in which a specific event is designated, and there are cases in which an arbitrary event is applied to a specific scene.

In the case of the “return event identification 1”, the rule processor 22 fixes the event to be an event x, and the initial scene is arbitrarily designated. In addition, a known software product 4 is used as a basis for differential development in order to obtain design data to be complemented, so that an input event required for setting the above-described initial scene is known, and the rule processor 22 can recognize and set the event.

The rule processor 22 instructs the input information generator 3 to generate the event that has been set as described above (STEP 34 and STEP 35). The input information generator 3 firstly inputs to the software product 4 the event designated for displaying the initial scene (STEP 34), and changes the display screen to the designated initial scene. After that, the input information generator further inputs in series a designated event p required for obtaining a single scene sequence (in this example, an event x being the “return event”) to the software product 4 (STEP 35). In the software product 4, the processing for the event p is carried out, whereby the display screen is changed to the display scene p (STEP 36). The model generator 5 inputs, after transition to the initial scene, a series of events inputted to the software product 4 (only a single event x for the example of the return event), and the information on the resultant scene change in the software product 4 (STEP 37). The rule processor 22 judges whether processing for a series of events, required for complementing one scene sequence, has been completed (STEP 38). If the processing has not been completed, the rule processor repeats the processing in STEP 35 through STEP 37 until the processing for the series of events, required for complementing the one scene sequence, is completed.

If it has been determined that one scene sequence is obtained, the rule processor 22 then judges whether the generation of k scene sequences to be complemented, which is prescribed in the applying process in the organizing rule “return event identification 2”, has been completed (STEP 39). If it has been completed, the model generator 5 generates k scene sequences of design data from the series of inputted events and the corresponding scene change information (STEP 40). The data is referred to as model design data. The model generator 5 complements the unorganized design data with the model design data, and stores the model design data in the unorganized design data storage 11 as well (STEP 41). The rule processor 22 re-evaluates and organizes the unorganized design data after the complement according to the “condition” of the “return event identification 1” in the organizing rules 213 (STEP 42). As described above, k series of events and k kinds of display scene data corresponding to the events, or namely k scene sequences, are generated and supplied to the unorganized design data. However, it is not certain whether design data for satisfying the “condition” of the “return event identification 1” is complemented, and it can be a case in which the “condition” of the “return event identification 1” is not satisfied again. In such a case, how many times the “return event identification 1” and the “return event identification 2” are repeated can be clearly written in each application process. FIG. 7 (c) illustrates an example of complemented model design data after such a complement process is carried out. After combining the design data in FIGS. 7 (b) and (c) to be considered as unorganized design data, as a result of re-evaluating the combined data according to the “return event identification 1” in the organizing rules 213, the “event x” is determined as a “return event”, and the unorganized data is converted into organized design data as illustrated in FIG. 7 (d).

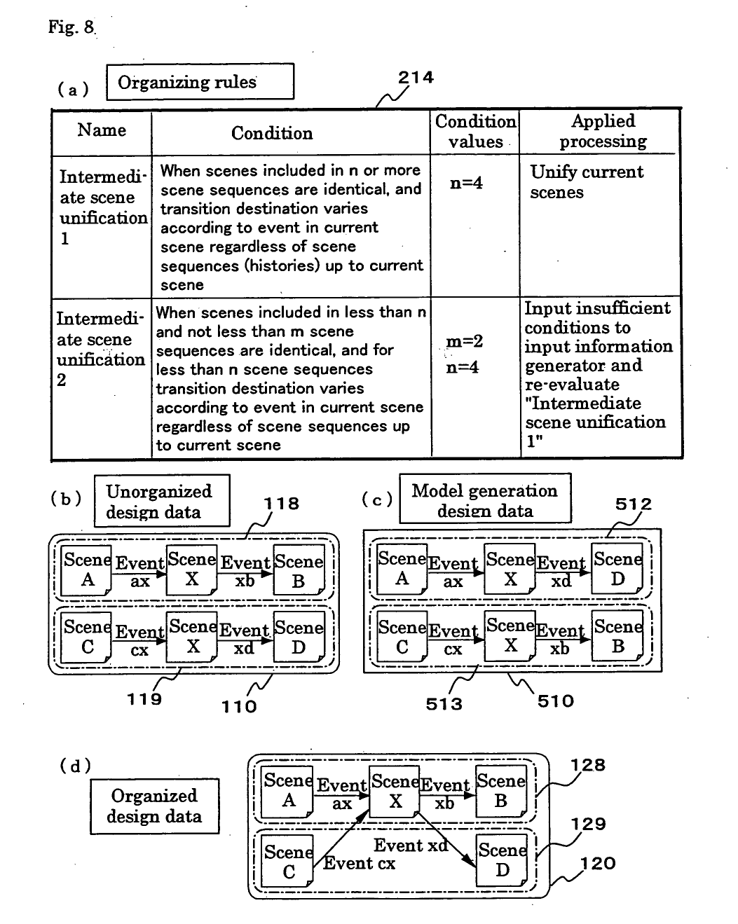

FIG. 8 illustrates another specific example of organizing rules, unorganized design data, and organized design data, for explaining the present embodiment. FIG. 8 (a) illustrates another example of organizing rules different from the organizing rules illustrated in FIG. 7 (a); FIG. 8 (b) illustrates an example of unorganized design data corresponding to the organizing rules; FIG. 8 (c) illustrates an example of model generation design data complemented in the same way as in FIG. 7 (c); and FIG. 8 (d) illustrates an example of organized design data having been organized according to the organizing rules.

The organizing rules 214 illustrated in FIG. 8 (a) are composed of an organizing rule “intermediate scene unification 1” and a subsequent organizing rule “intermediate scene unification 2”. The rule “intermediate scene unification 1” prescribes that in a case in which intermediate scenes are identical between a plurality of scene sequences, and, regardless of scene sequence segments up to the scene (or the histories), the destination of transition is determined depending only on events in the scene, if the number of such scene sequences is n or larger, then the scene sequences are unified. Meanwhile, the rule “intermediate scene unification 2” prescribes that even if the number of scene sequences is smaller than n, and if the number is m or larger, the “applying process” in the “intermediate scene unification 2” is carried out, or more specifically, after complementing design data and returning to the “intermediate scene unification 1”, re-evaluation is carried out. The conversion from the unorganized design data into the organized design data in this example is carried out as described below. It should be noted that the procedures described in FIG. 2 and FIG. 6 are the same in this example, so that their correspondence to the steps in FIG. 2 and FIG. 6 will be hereinafter omitted.

The unorganized design data in the example includes two scene sequences 118 and 119 being unorganized design data as illustrated in FIG. 8 (b). Both the scene sequences include a scene X, and the immediately following scenes do not depend on scene sequence segments to reach the scene X (or histories), and are determined only by events with respect to the scene X. More specifically, a scene after the event occurrence moves to a scene B if the event is an event xb, and the scene moves to a scene D if the event is an event xd. The rule processor 22 applies the organizing rule “intermediate scene unification 1” to the unorganized design data to try to perform organization. In the example of the “intermediate scene unification 1”, the “condition value” is designated as n=4, and the “condition” of the “intermediate scene unification 1 is not satisfied only by two examples of unorganized design data 118 and 119. Therefore, the rule processor 22 determines that the unorganized design data 118 and 119 cannot be unified to be organized, and then moves to evaluation according to the organizing rule “intermediate scene unification 2”. Because the “condition value” of the “intermediate scene unification 2” is designated as m=2 in the example, the “condition” is satisfied only by the two examples of unorganized design data 118 and 119. Then the rule processor 22 moves to the processing for complementing insufficient design data as a portion of unorganized design data. The complement procedure is the same as described in the explanation of FIG. 7, and the model design data generated by the model generator 5 is illustrated as scene sequences 512 and 513 in FIG. 8 (c). The model generator 5 adds the scene sequences to the unorganized design data 110, and the rule processor 22 re-evaluates the unorganized design data after the complement according to the organizing rule “intermediate scene unification 1”. In this case, the number of scene sequences to which the “condition” applies increases from the original two to four, so that the “condition” is satisfied. Therefore, the rule processor 22 performs the processing written in the field of “applying process” in the “intermediate scene unification 1” for the unorganized design data after the complement. As a result, the unorganized design data 118 and 119 is complemented with two model generation design data 512 and 513 illustrated in FIG. 8 (c), and then converted into a unified organized design data 128 as illustrated in FIG. 8 (d).

As described in the above two examples, when the condition cannot be satisfied in terms of the number of data segments only by the unorganized design data stored in the design data storage 1, and the data cannot be well organized, the rule processor 22 sends an instruction for generating insufficient unorganized design data to the input information generator 3. The input information generator 3 having been received the instruction generates an event, and inputs the event into the software product 4. The model generator 5 generates model design data from the event inputted to the software product 4 and the scene change in the software product 4 caused by the input, complements the model design data as a portion of the unorganized design data, and stores the unorganized design data in the unorganized design data storage 11 as well. The rule processor 22 performs the same processing as the processing described in Embodiment 1 on the unorganized design data after the complement, and converts the unorganized design data into organized design data. Organized as described above, design data that has been unable to be organized due to insufficiency of design data can be organized, so that design data in more reusable form can be obtained. As described above, according to the present embodiment, the same effects as the effects of Embodiment 1 can be expected in wider range of cases.

According to the present embodiment, in addition to the above effects, even when a user interface software design system is used for the first time, certain level of effects can be expected. More specifically, even when unorganized design data 1 has not been accumulated in the unorganized design data storage 11, model design data can be easily generated via a software product 4 as a basis for differential development by the above-described process. The model design data, regarded as unorganized design data accumulated in the past, can be converted into organized design data. Therefore, from an early stage of using the user interface software design system, design and development can be performed more efficiently. Moreover, the present embodiment is not limited to the organizing rules described as examples here, but can be applied to other organizing rules in the same manner, and the same effects as above can be achieved.

In addition, in the above description, two types of organizing rules have been explained as examples. However, the invention relevant to the present embodiment is not limited to these organizing rules, and the same effects can be achieved for other organizing rules. Moreover, the organizing rules have been expressed in table form, but are not limited to table form. It is only necessary that “conditions (including condition values)” and “applying process” that is performed when the conditions are satisfied are described therein. For example, even if the organizing rules are expressed in IF-THEN rules or other forms, effects similar to the above can be achieved. In addition, the relation between the unorganized design data storage 11 and the organized design data storage 12, and the design data storage 1 can be arbitrarily configured as having been described. In any of the configurations, effects similar to the above can be achieved.

Moreover, in the same way as the explanation in Embodiment 1, the rule processor 22 can apply all the organizing rules to the unorganized design data a plurality of times. In a plurality of times of applications, the organized design data in the previous cycle is treated as unorganized design data. By repeatedly applying organizing rules as just described, the organization of the design data is promoted, and the design data can be converted into more reusable design data.

### Embodiment 3

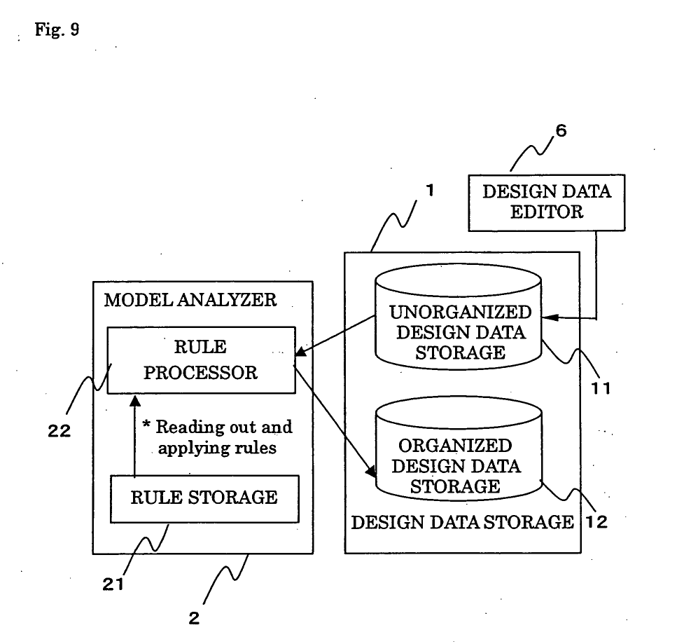

FIG. 9 illustrates the configuration of Embodiment 3 of the present invention. It is so configured that a design data editor 6 is added to the configuration of Embodiment 1. The design data editor 6 is a means for editing unorganized design data stored in the unorganized design data storage 11. A software designer can use the design data editor 6 to specify to preferentially apply to specific unorganized design data 110 an organizing rule referred to as a rule template, preset separately from the organizing rules that have been described. The rule template is stored in the rule storage 21 separately from the organizing rules that have been described. Because a plurality of rule templates can be used, in the designation by the design data editor 6, not only designation of target unorganized design data, but also designation of the name (or an identifier such as a number and a symbol, hereinafter abbreviated to the “name”) of a rule template to be preferentially applied can be included. For example, a preferential application recording field is provided for individual design data included in unorganized design data, and a software designer inputs in advance to the field the name and the like of a rule template to be preferentially applied.

The preferential application of a rule template is necessary in a case, for example, in which it is known in advance that, in scene sequences within unorganized design data, specific scene sequence segments have specific forms, and are related to the precedent or subsequent scenes. In some cases, for such unorganized design data, design intent can be more appropriately expressed to apply a “rule template” in accordance with the scene sequence segments having the specific forms than to automatically apply organizing rules stored in the rule storage 21.

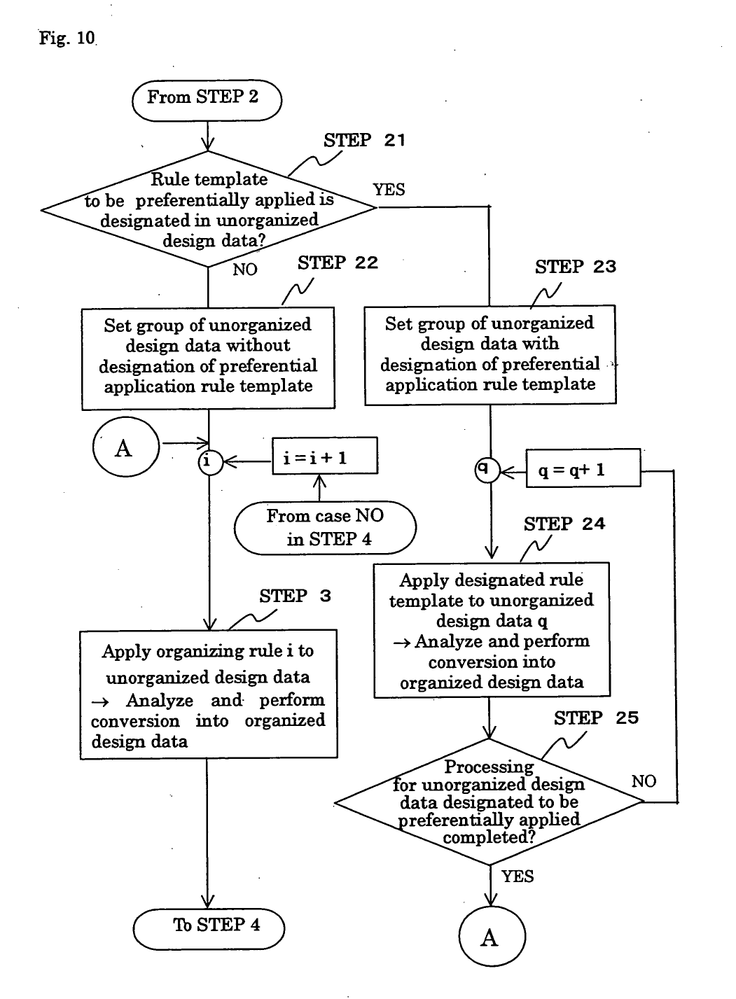

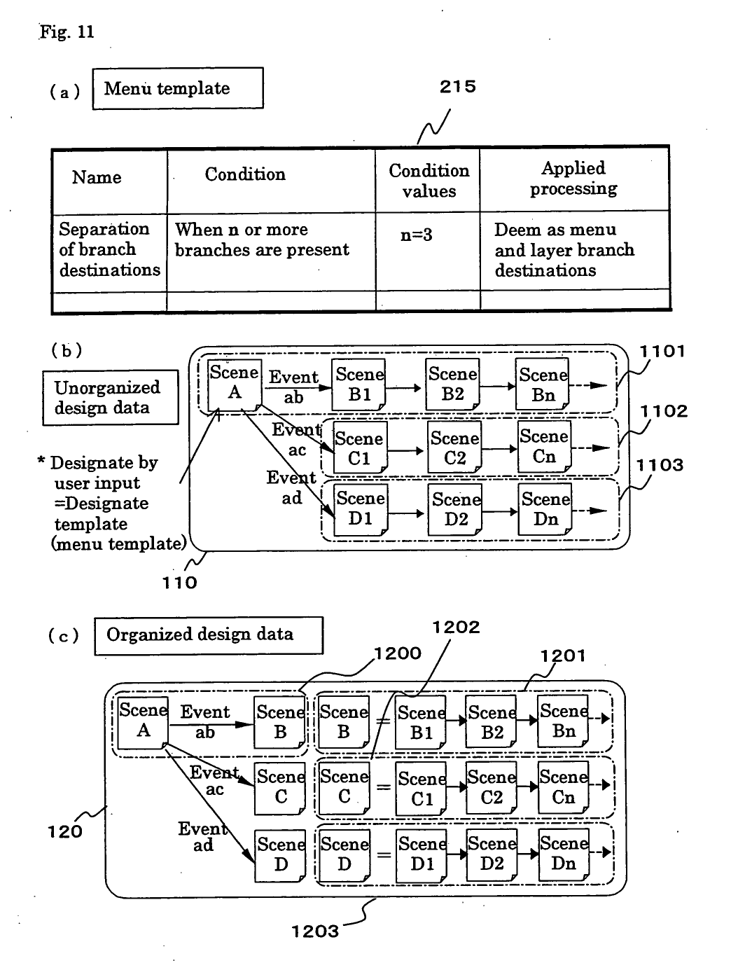

FIG. 10 illustrates the processing relevant to the present embodiment, and the processing is inserted between STEP 2 and STEP 3 in FIG. 2. In addition, FIG. 11 illustrates a specific example used for explanation of the present embodiment. FIG. 11 (a) illustrates a menu template 215 as a specific example of a rule template. The content thereof is as written in the table in FIG. 11 (a). FIG. 11 (b) illustrates unorganized design data 1100, and FIG. 11 (c) illustrates organized design data after the unorganized design data 110 is organized according to the menu template 215. Here, the software designer is assumed to recognize the possibility that a scene A included in the unorganized design data 1100 in FIG. 11 (b) is a menu scene. Therefore, it is assumed that the software designer, using the design data editor 6, has written in advance in the preferential application recording field of the unorganized design data 1100 the name of the menu template 215 as a name of the rule template to be preferentially applied. Hereinafter, the procedure for processing unorganized design data by the rule processor 22 will be described according to FIG. 10 and FIG. 11. The procedure is started from STEP 1 in FIG. 2. However, the procedure up to STEP 2 is the same as in Embodiment 1, so that the explanation thereof will be omitted here. After performing STEP 2, the rule processor 22 judges whether designation of a rule template to be preferentially applied is present in the unorganized design data (STEP 21). If designation is not present, the processing returns to STEP 3 in FIG. 2, and if designation is present, the processing by the rule template designated for the unorganized design data (in the present example, the menu template 215) is performed (STEP 21). In the example in FIG. 11, the unorganized design data 1100 includes the designation, so that the unorganized design data is to be processed in STEP 22.

The procedure in STEP 22 will be described in detail below. In the menu template 215 illustrated in FIG. 11 (a), “applying process” titled “layering of branch destinations” and the “condition” for applying the process are written. The rule processor 22 analyzes the scene sequence 1100 according to the “condition” written in the menu template 215, and if a scene A has n or more branches, the scene A is determined to be a menu scene. In the example, the scene A branches to scene sequence segments 1101 through 1103, so that n=3, and the “condition value” in FIG. 11 (a) is satisfied. Therefore, the scene A is deemed as a menu scene, and the processing for “layering of branch destinations” is performed for the unorganized design data 1100 according to the “applying process” in FIG. 11 (a). As a result, the unorganized design data 1100 is converted into four layered segments of organized design data 1200 through 1203 illustrated in FIG. 11 (c).

Next, a variation of the present embodiment will be described. Here, the software designer, using the design data editor 6, designates in advance specific unorganized design data as data to which organizing rules are “not applicable”. The designated design data, or the scene sequence, is exempted from application of organizing rules. The processing according to the designation is often required in such a case in which design data that has been organized to a certain extent is organized again.

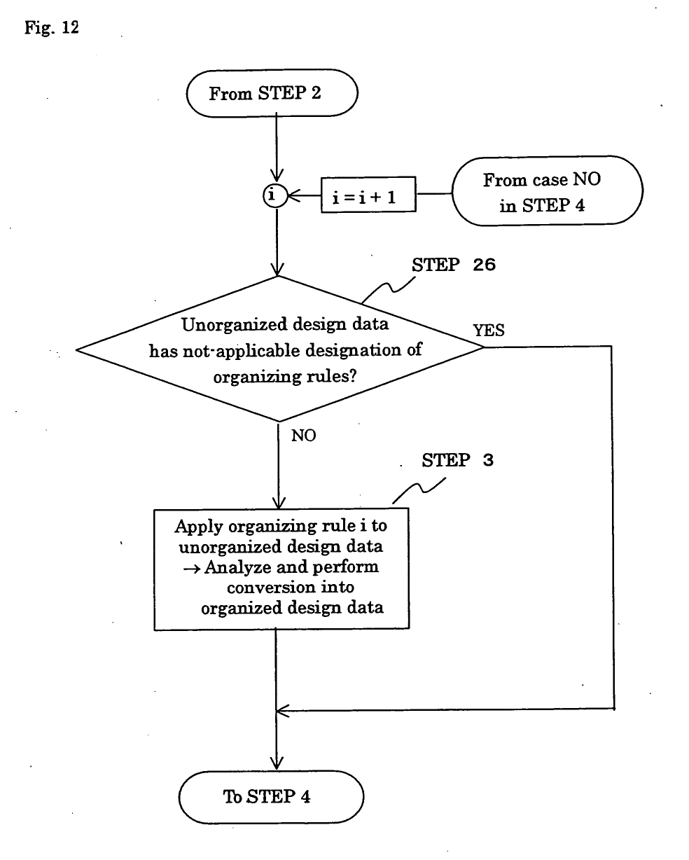

As illustrated in FIG. 12, STEP 23 for determining whether non-application designation is present is inserted before moving to STEP 3 in FIG. 2. If the designation is not present with respect to unorganized design data, the same processing as in Embodiment 1 is performed, and if the designation is present, STEP 4 in FIG. 2 ensues, and organizing rules are not applied to the unorganized data. The non-application designation field can be provided independently, or can be shared with the designation field for organizing rule preferential application described using FIG. 10 and FIG. 11.

In addition, this function can be also used when it is desired that the organized design data is organized again from another viewpoint. Specifically, the software designer designates using the design data editor 6 “exclusion of organization application (non-application)” with respect to design data that has been organized to a certain extent and that is not wanted to be organized any more. Then, the rule processor 22 instructs to store as unorganized design data in the unorganized design data storage the entire design data that has been organized to a certain extent including the design data having non-application designation, and applies the organizing rules again to the unorganized design data so as to perform organization.

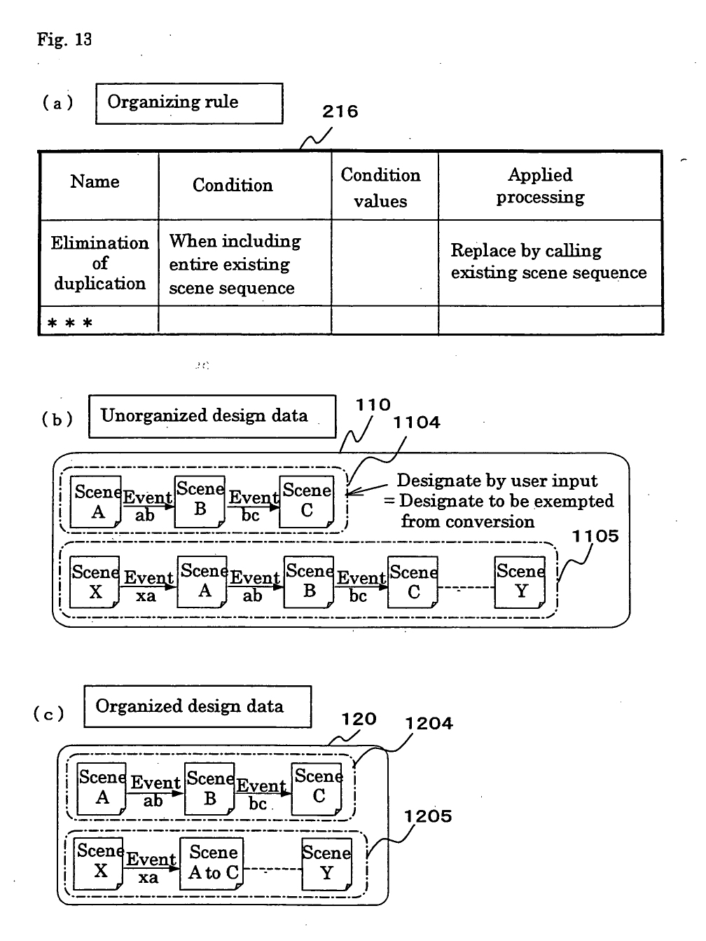

A specific example is illustrated in FIG. 13. An organizing rule 216 in FIG. 13 (a) is an example of an organizing rule to be applied to normal unorganized design data, FIG. 13 (b) illustrates unorganized design data, and FIG. 13 (c) illustrates organized design data. It is assumed that unorganized design data 1104 is designated as “non-application”. The rule processor 22 exempts the unorganized design data 1104 from the application of the organizing rule 216, and does not perform any analysis and processing according to the organizing rule 216. However, the analysis and conversion are performed with respect to other unorganized design data having no non-application designation, for example, a scene sequence 1105, which is converted into a scene sequence 1205 illustrated in FIG. 13 (c). More specifically, the scene sequence 1105 includes the same scene sequence segment as the existing scene sequence 1104 that is design data having been organized to a certain extent, so that the scene sequence segment is replaced by calling the existing scene sequence. In order to perform such replacement, a scene sequence that is a basis for the replacement must be preserved so as not to be converted and transformed. For that purpose, the scene sequence being design data is designated as “non-application” in advance.

As described above, introduction of the design data editor 6 enables a software designer to perform not only analysis and conversion according to automatic application of organizing rules, but also organization of design data in accordance with individual design data situation in reflection of the designer's intent, so that more reusable design data can be configured. In addition, in the above-described example, a design data editor 6 is used as a means for designating the preferential application of rule templates, and a means for designating the exclusion of application of organizing rules. However, any means that can substantially perform above-described designation for design data may be used instead of an “editor”, and the same effects as in the present embodiment can be achieved. Moreover, although in the present embodiment, an example in which a design data editor 6 is added to a system illustrated in FIG. 1 of Embodiment 1 has been described, even in a case in which a design data editor is added to a system illustrated in FIG. 5 of Embodiment 2, the same effects as those described in the present embodiment can be achieved.

Moreover, the invention relevant to the present embodiment is not limited to the exemplified organizing rules, and the same effects can be achieved when using other organizing rules. Moreover, the organizing rules have been expressed in table form, but are not limited to table form. It is only necessary that “conditions (including condition values)” and “applying process” that is performed when the conditions are satisfied are described therein. For example, even if the organizing rules are expressed in IF-THEN rules or other forms, effects similar to the above can be achieved. In addition, the relation between the unorganized design data storage 11 and the organized design data storage 12, and the design data storage 1 can be arbitrarily configured as having been described. In any of the configurations, effects similar to the above can be achieved.

Moreover, in the same way as the explanation in Embodiment 1, the rule processor 22 can apply all the organizing rules to the unorganized design data a plurality of times. In a plurality of times of applications, the organized design data in the previous cycle is treated as unorganized design data. By repeatedly applying organizing rules as just described, the organization of the design data is promoted, and the design data can be converted into more reusable design data.

### Embodiment 4

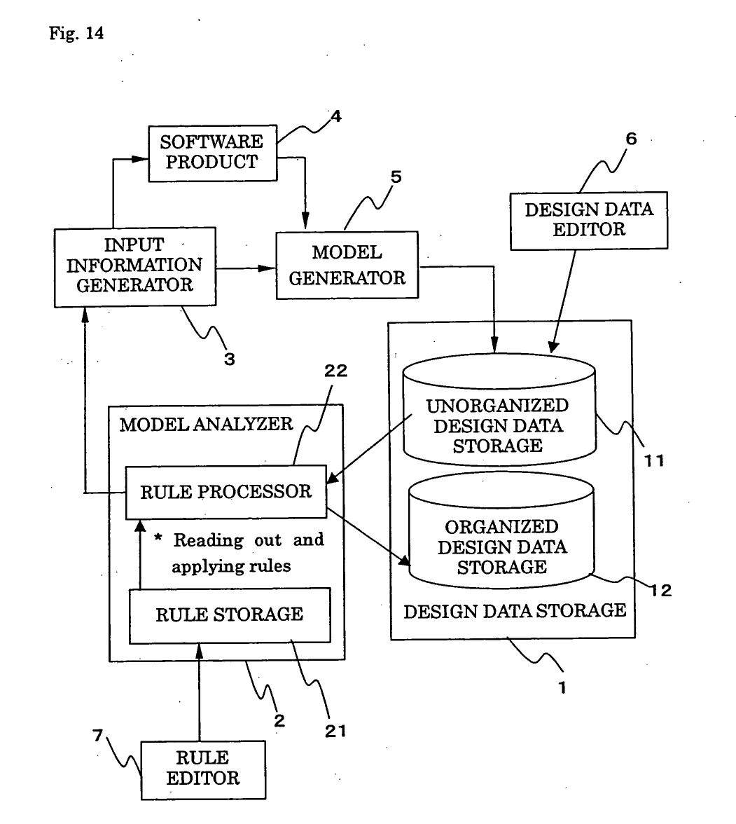

Embodiment 4 is configured such that a rule editor 7 is added to any of the embodiments having been described. The rule editor 7 enables a software designer to perform operations such as addition, removal, and modification of organizing rules or templates stored in the rule storage 21, and to change the order of applying the rules as well. Providing such a means makes it possible to improve the organizing rule group or to make rule-applying processes appropriate, and as a result a software designer can organize design data more effectively. According to the above, more reusable design data that has been organized in a form in which design intent is easily understandable can be configured. In addition, FIG. 14 illustrates Embodiment 4 of the invention in a case in which all the components of Embodiment 1 through Embodiment 3 are included.

### INDUSTRIAL APPLICABILITY

The present invention is used for design and development of user interface software that is part of software in the field of devices equipped with software products, such as cellular phones, personal digital assistants, and car navigation devices.

1. A user interface software design system comprising:
an unorganized design data storage for storing, as unorganized design data, user-interface-software design data including events directed to a software product and information on software-product scene changes corresponding to the events;
a rule storage for storing an organizing rule group, the organizing rule group being a collection of organizing rules describing rules for converting the unorganized design data into reusable form;
a rule processor for converting the unorganized design data into organized design data by reading out the unorganized design data stored in the unorganized design data storage and reading out the organizing rule group stored in the rule storage, and applying, in sequence, to the read-out unorganized design data each organizing rule included in the read-out organizing rule group, to analyze the unorganized design data; and
an organized design data storage for storing the organized design data according to instruction by the rule processor.

2. The user interface software design system according to claim 1, wherein, according to instruction by the rule processor, the organized design data is deemed to be unorganized design data, and the unorganized design data is converted into organized design data by applying in sequence, again, to the unorganized design data the organizing rules included in the organizing rule group, and by analyzing the unorganized design data.

3. The user interface software design system according to claim 1, further comprising:
an input information generator for generating an event directed to a software product as a basis for differential development, and inputting the event into the software product; and
a model generator for receiving the event input into the software product and the information on the software-product scene change for the event input, and generating data, as additional design data, for the user interface software, including the event and the scene change information, wherein the rule processor converts into organized design data new unorganized design data generated by adding the additional design data generated by the model generator to the unorganized design data.

4. The user interface software design system according to claim 3, wherein, when the rule processor analyzes the unorganized design data according to the organizing rules and determines that additional design data is necessary, the rule processor sends to the input information generator an instruction for generating required additional design data, whereby the input information generator generates the event directed to the software product, and inputs the event into the software product.

5. The user interface software design system according to claim 1, wherein specific design data within the unorganized design data has a designation field for designating either preferential application of an organizing rule designated in advance, or non-application of the organizing rules, and the user interface software design system further comprises a design data editor for enabling the designating into the designation field.

6. The user interface software design system according to claim 1, further comprising a rule editor for editing the organizing rules according to input information.

7. The user interface software design system according to claim 1, wherein the unorganized design data storage and the organized design data storage are shared in a design data storage, and the unorganized design data and the organized design data are stored in different areas within the design data storage.

8. The user interface software design system according to claim 1, wherein the unorganized design data storage and the organized design data storage are shared in a design data storage, and the organized design data is stored in the design data storage by rewriting the unorganized design data stored in the design data storage with the organized design data.
